(19) United States
(12) Patent Application Publication
(10) Pub. No.: US 2004/0207767 A1
(43) Pub. Date: Oct. 21, 2004

(54) IMAGE TRANSMISSION SYSTEM OF REAR PROJECTION TELEVISION

(76) Inventors: Yi-Jen HU, Miao-Li County (TW); Yung-Liang LEE, Miao-Li County (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,553

(22) Filed: Mar. 11, 2004

(30) Foreign Application Priority Data
Mar. 26, 2003 (TW) 092107337

(51) Int. Cl. G06K 1/00

(52) U.S. Cl. 348/744; 348/789

(57) ABSTRACT

An image transmission system for a rear projection television includes a main board module and an optical engine module connected to the main board module. When the system actuates, the main board module receives control and image signals to allow a CPU of the main board module commanding a CPU of the optical engine module. The CPU of the optical engine module commands a light valve unit of the optical engine module to generate images that are then projected onto a screen. Because each module is controlled by its corresponding CPU and has a standardized connection port, the modules can be separately debugged and easily connected to external peripherals, thereby reducing the research and development time.

### BACKGROUND OF INVENTION

1. Field of the Invention

The present invention relates to an image transmission system, and more particularly to an image transmission system of a rear projection television.

2. Description of the Prior Art

Referring to FIG. 1, a conventional image transmission system of a rear projection television includes an optical engine module 11, an optical engine module 12 and a screen 13. The optical engine module 11 includes a control unit 111, a processing unit 112 and a memory unit 113 to control the operation of the while image transmission system 10. The optical engine 12 includes an illumination unit 121, a light vale driver chip 122, a light valve 123 and a projecting lens 124 to transform the image data into image pictures that are then projected onto a screen 13.

When a personal computer (PC) 1 or video and audio player 2 transmits an image signal to the main board module 11, the control unit 111 transmits a command or control signal to allow the processing unit 112 to encode image data, transform image signals and scale up and down images, and further to control the optical engine module 12 to send the image data to the light valve driver chip 122. The driver chip 122 transforms the image data into the format acceptable by the light valve 123, and then transmits the image data to the light valve 123. The light valve 123 transforms the light incident from the illumination unit 121 and the image signal into image beams that are then projected via the projecting lens 124 to form the images. A reflector (not shown) reflects the image pictures onto the screen 13.

Typically, the control unit 111 of the main board module 11 controls parallel or series commands and control signals that are used to control the optical engine module 12. Therefore the commands or the signals cannot work if the main board module 11 is disconnected to the optical engine module 12.

Since the optical engine module 12 operates under the control of the main board module 11, which cannot allow the optical engine module 12 individually debugging and cannot be debugged until the main board module 11 has be developed. Failing to individually debug the optical engine module 12 and the main board module 11 leads to time-consuming development and low controllability.

Furthermore, the optical engine module 12 intimately relies on the control unit 111 of the main board module 11, which increases the difficulty in production with special tools and highly limits the applicability of these two modules.

### SUMMARY OF INVENTION

It is one object of the invention to provide an image transmission system of a rear projection television, in which a main board module and an optical engine module respectively has a UPC unit so that the modules are individually debugged and developed to reduce development time.

It is another object of the invention to provide an image transmission system of a rear projection television, in which a standardized interface is provided between the main board module and the optical engine module to increase the compatibility between the modules and other peripherals, thereby increasing the yield and test efficiency.

Furthermore, it is another object of the invention to provide an image transmission system of a rear projection television, in which individually operable main board module and optical engine module can respectively work as a single module.

In order to achieve the above and other objectives, the image transmission system of the projection television according to the invention includes a main board module and an optical engine module connected to the main board module. The main board module includes a CPU unit, a signal-scaling unit and an image-transforming unit. The CPU unit controls the whole processing of image transmission. The signal-scaling unit is responsible for processing the image data transmitted to the main board module and then transmitting the processed image data to the main board module. The optical engine module includes a CPU module, an image-receiving unit, a light valve unit, an illumination unit and a projection lens. The CPU unit controls the units of the optical engine module. The image-receiving unit receives the image data output by the image-transforming unit and then transmits the image data to the light valve unit. The light valve includes a light valve driver and a light valve. The light valve driver transforms the image data output by the image-receiving unit into a format acceptable by the light valve, and then transmits the image data to the light valve. The illumination unit emits beams into the light valve by which the beams are processed to generate image pictures. The image pictures are then projected onto a screen by a projecting lens. When the system actuates, the main board module receives control signals and image signals to drive the CPU unit to give the CPU unit of the optical engine module control commands to control the light valve unit to generate the image pictures on the screen.

It will be understood that the foregoing summary encompasses some of the many features of the invention, and does not constitute an exhaustive description of all the aspects of the invention. Therefore, the summary of the invention should not be construed in a way to limit the scope of the invention as descried in the claims. To provide a further understanding of the invention, the following detailed description illustrates embodiments and examples of the invention.

### BRIEF DESCRIPTION OF DRAWINGS

FIG. 1 is a block diagram of a conventional image transmission system of a rear projection television;

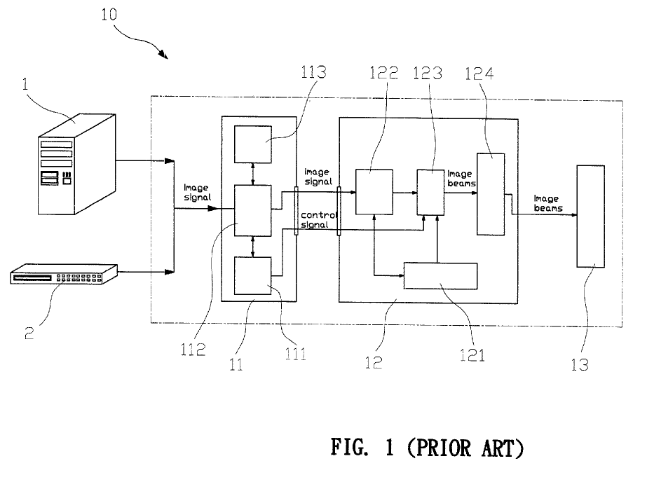

FIG. 2 is a block diagram of an image transmission system of a rear projection television according to one embodiment of the invention;

FIG. 3 is a schematic view of a main board module assembled with a test device according to one embodiment of the invention; and

FIG. 4 is a schematic view of an optical engine module assembled with a test device according to one embodiment of the invention.

### DETAILED DESCRIPTION

The following description of the present invention is intended to be illustrative only and not limiting.

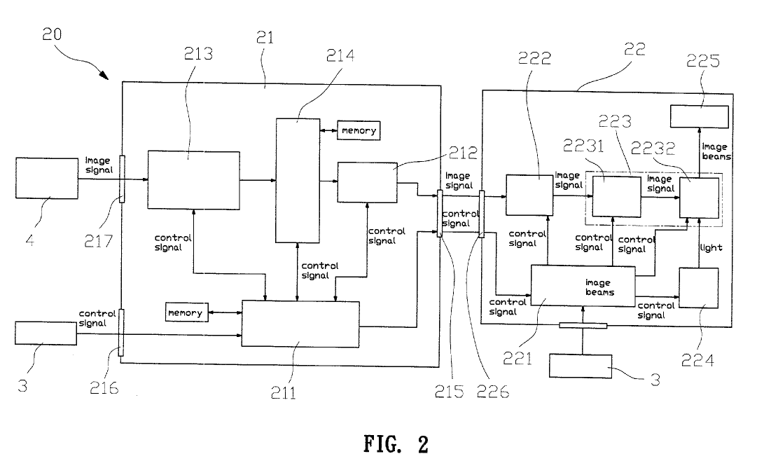

As shown in FIG. 2, an image transmission system 20 of a rear projection television according to the invention includes a main board module 21 and an optical engine module 22 connected to the main board module 22. The main board module 21 includes a CPU unit 211, an image-transforming unit 212, an image signal transceiver unit 213 and a signal-scaling unit 214. The CPU unit 211 commands to other units to control the whole system process. The image transceiver unit 213 and the signal scaling module 214 are respectively responsible for receiving and processing the image data transmitted from the main board module 21, and transmitting the processed image data to the image transforming unit 212 that transforms the image data into the format acceptable by the optical engine module 22 or a display device, such as the format of transition minimized differential signaling (TMDS) or video graphic array (VGA). The image data is then transmitted to a connecting port 215. The main board module 21 has an input port 216 for connecting an input device such as a control panel 3 or PC. Different control signals are input to the CPU unit 211 via the input device to allow the main board module 21 executing different operational modes.

The optical engine module 22 connects to the main board module 21. The optical engine module 22 includes a CPU unit 221, an image receiving unit 222, a light valve unit 223, an illumination unit 224 and a projecting lens 225. The CPU unit 221 gives commands to control other units of the optical engine module 22. The image-receiving unit 222 connects to a connecting port 226 to receive the image data output from the image-transforming unit 212. The image data is then transmitted to the light valve unit 223. The light vale unit 223 includes a light valve driver 2231 and at least one light valve 2232. The light valve driver 2231 transforms the image data output from the image-receiving unit 222 into a format acceptable by the light valve 232 and then transmits the image data to the light valve 2232. The light valve 2232 can be a digital micro-mirror device (DMD), a liquid crystal on silicon (LCOS), or a liquid crystal display panel (LCD Panel). The illumination unit 224 provides uniform zed beams that then enter the light valve 2232. The beams passing through the light valve 2232 generate image pictures that are then projected onto a screen (not shown).

The connecting ports 215, 226 of the optical engine modules 21, 22 can have digital interface or analog interface. The interface is provided with a standard signal connector. For example, the interface is preferably a digital visual interface (DVI) or a VGA interface to increase compatibility. The main board module 21 connects to the optical engine 22 via an image transmission interface to accomplish the image transmission system of the rear projection television. When the system is actuated, the main board module 21 receives the control signals via the input port 216 and receives image signals from an image signal generating device 4 such as DVD, PC or pattern generator to have the CPU unit 211 give commands control signals to process and transmit image data to the optical engine module 22. The CPU unit 211 also gives commands or control signals to the CPU unit 221 of the optical engine 22. Then, the CPU unit 221 controls the light valve unit 223 to generate image pictures and display the image pictures onto the screen.

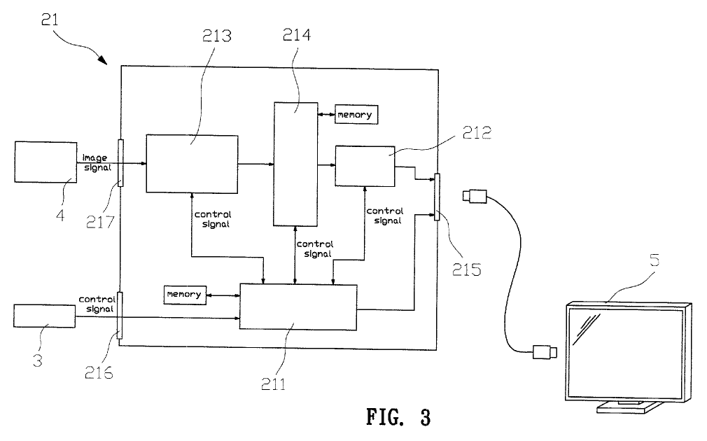

As illustrated in FIG. 3, the operation of the optical engine module 21 is as follows. One connecting port 217 of the optical engine module 21 connects to an image signal-generating device 4 such as DVD, PC or pattern generator. The other connecting port 215 connects to a display device 5 such as a liquid crystal display or CRT display device. The image data received by the main board module 21 is processed in sequence and then transmitted to the image transforming unit 212 to transform the image data into a format acceptable by the display device 5 such as TMDS or VGA. Then the image data can be output onto the display device 5, and can be debugged. Therefore, it is not necessary to connect to the optical engine module 22 for debugging. Furthermore, the input port 216 of the main board module 21 connects to an input device such as a control panel 3 or a PC to input different control signals for different operation modes (such as test mode or normal mode) of the main board module 21.

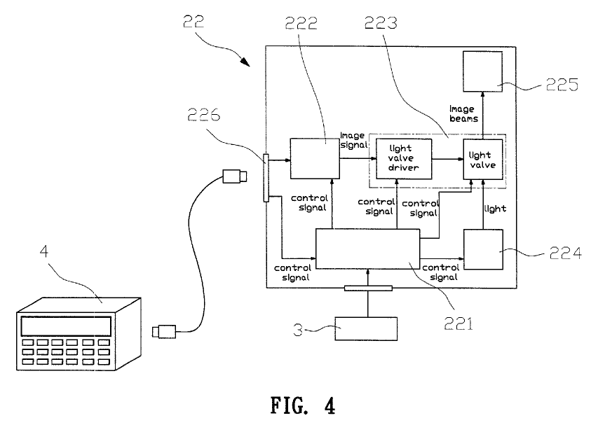

Referring to FIG. 4, the operation of the optical engine module 22 according to the invention is as follows. The connecting port 226 connects to an image signal-generating device 4 such as a PC or a pattern generator and then connects to an input device such as a control panel 3 or a PC for inputting different control signals to the CPU unit 221. Under the control of the input device 3, the CPU unit 221 gives commands or control signals to drive the optical engine module to debug. Therefore, there is no need to connect the optical engine module 22 to the main board module 21 for debugging. When the CPU unit 221 needs complex control signals for operation, the PC and a keyboard can be used for inputting the control signals.

The main board module 21 and the optical engine module 22 respectively have the CPU modules 211, 221 to individually drive the main board module 21 and the optical engine module 22 to operate. Therefore, debugging and developing the modules can be individually done. Then, a standardized digital interface and an analog interface can be used to integrate the main board module and the optical engine module. Thereby, the development time and the test difficulty may be reduced, while the compatibility of the modules with other peripherals and the yield must be increased. Furthermore, the individually operable main board module and the optical engine module can be applied for different product demands. For example, the same main board modules can be assembled with optical engine modules of LCD, LCOS or DMD etc. The invention has advantages such as broadened application range and reduced production cost.

Those skilled in the art will readily understand that the above description is only illustrative of specific embodiments and examples of the invention, which should not be construed in a limiting way. Therefore, the invention should cover various modifications and variations made to the structure and operations described herein, provided they fall within the scope of the invention as defined in the following appended claims.

What is claimed is:

1. An image transmission system of a rear projection television, comprising:
a main board module, having a CPU unit and a signal scaling unit, wherein the CPU unit controls the signal scaling unit to process image signals that are received; and
an optical engine module, connected to the main board module to receive image data from the main board module, wherein the optical engine includes a CPU module and at least one light valve unit, the CPU unit controlling the operation of the light valve unit.

2. The system of claim 1, wherein the CPU unit of the main board module transmits control signals to the CPU unit of the main board module.

3. The system of claim 1, wherein the main board module and the optical engine module respectively have an analog-interface connecting port.

4. The system of claim 1, wherein the main board module and the optical engine module respectively have a digital-interface connecting port.

5. The system of claim 1, wherein the main board module and the optical engine module respectively have a DVI signal connecting port.

6. The system of claim 1, wherein the main board module and the optical engine module respectively have a VGA signal connecting port.

7. The system of claim 1, wherein the main board module connects to an input device, and the CPU unit of the main board module controls different operation modes of the main board module according to signals form the input device.

8. The system of claim 1, wherein the optical engine module connects to an input device, and the CPU unit of the optical engine module controls different operational modes of the optical engine module according to signals from the input device.

9. The system of claim 1, wherein the light valve unit includes a light valve and a light valve driver, the light valve driver transforms the image data into a format acceptable by the light valve and then transmits the image data to the light valve.

10. The system of claim 1, wherein the optical engine module further includes an image-receiving unit connected to the light valve unit to receive the image data.

11. The system of claim 10, wherein the main board module further includes an image-transforming unit to transform the image signals into a format acceptable by the image-receiving unit of the optical engine module.

12. The system of claim 1, wherein the optical engine module further comprising:
an illumination unit, emitting beams into the light valve unit; and
a projecting lens, projecting the beams from the light valve unit to generate image pictures onto a screen.

13. The system of claim 1, wherein the main board module further comprises an image signal transforming and an image-receiving unit connected to the signal-scaling unit for receiving the image signals.

14. An optical engine module, comprising:
a CPU unit; and
at least an optical valve unit connected to the CPU unit by which the operation of the optical engine unit is controlled.

15. The optical engine module of claim 14, wherein the optical engine module has an analog-interface connecting port.

16. The optical engine module of claim 14, wherein the optical engine module has a digital-interface connecting port.

17. The optical engine module of claim 14, wherein the optical engine module has a DVI signal connecting port.

18. The optical engine module of claim 14, wherein the optical engine module has a VGA signal connecting port.

19. The optical engine module of claim 14, wherein the optical engine module connects to an input device, and the CPU unit of the optical engine module controls different operation modes of the optical engine module according to signals form the input device.

20. The optical engine module of claim 14, wherein the light valve unit includes a light valve and a light valve driver, the light valve driver transforms the image data into a format acceptable by the light valve and then transmits the image data to the light valve.

21. The optical engine module of claim 14, wherein the optical engine module further includes an image-receiving unit connected to the light valve unit to receive the image data.

22. The optical engine module of claim 14, wherein the optical engine module further comprises
an illumination unit, emitting beams into the light valve unit, and
a projecting lens, projecting the beams from the light valve unit to generate image pictures onto a screen.
